(19) United States
(12) Patent Application Publication
(10) Pub. No.: US 2013/0235559 A1
(43) Pub. Date: Sep. 12, 2013

(54) Spectrally Transflective Display

(71) Applicant: Johan Lars Bergquist, Tokyo (JP)

(72) Inventor: Johan Lars Bergquist, Tokyo (JP)

(73) Assignee: Nokia Corporation

(21) Appl. No.: 13/412,729

(22) Filed: Mar. 6, 2012

(51) Int. Cl. G09F 13/04

(52) U.S. Cl. 362/97.1

(57) ABSTRACT

The specification and drawings present a new apparatus and method for using a spectrally selective mirror/filter to facilitate high efficiency of backlighting and high reflectivity of ambient light in an electronic display. The spectrally selective mirror/filter (or optical filter) may be placed between an upper display (spatial light amplitude modulator) and a backlight unit comprising light sources generating primary colors such as RBG of a display color gamut. This optical filter has a high reflectivity of visible light except for narrow-band transmission windows substantially coinciding with the primary colors.

### TECHNICAL FIELD

The exemplary and non-limiting embodiments of this invention relate generally to electronic displays and more specifically to using a spectrally selective mirror/filter to facilitate high efficiency of backlighting and high reflectivity of ambient light.

### BACKGROUND ART

The following abbreviations that may be found in the specification and/or the drawing figures are defined as follows:
3M Minnesota mining and manufacturing corporation
ALPM advanced low-power mode
ALS ambient light sensor
CCT correlated color temperature
CLC Cholesteric LC
D65 model illuminant spectrum similar to daylight with a CCT of 6500 K
DBEF dual brightness enhancement film, often incorporates a reflective polarizer
E-book electronic book
FSC field-sequential color
FWHM full width at half maximum
ESR enhanced specular reflectors
iMoD interferometric modulator
ITO indium tin oxide
LC liquid crystal
LCD liquid crystal display
LED light-emitting diode
LASER light amplification by stimulated emission of radiation
MEMS micro-electro-mechanical systems
NTSC national TV standard committee
OLED organic light-emitting diode
RBG red, blue, green
RM reactive mesogen
TF-OLED transflective OLED
TM transmissive

### SUMMARY

According to a first aspect of the invention, an apparatus, comprising: an upper display comprising a spatial light amplitude modulator; a backlight unit, comprising light sources generating primary colors of a display color gamut; and an optical filter located between the upper display and the backlight unit and having a high reflectivity of visible light except for narrow-band transmission windows substantially coinciding with the primary colors.

According to a second aspect of the invention, a method comprising: receiving from a backlight unit of a display and transmitting to an upper display light comprising primary colors of a color gamut by an optical filter using narrow-band transmission windows substantially coinciding with the primary colors; and receiving and reflecting by the optical filter an ambient light using a high reflectivity of the optical filter in a visible part of spectrum except for the narrow-band transmission window, where the optical filter is located between the upper display and the backlight unit.

According to a third aspect of the invention, an electronic device, comprising: a controlling and processing unit; an optical engine operatively connected to the data processing unit for receiving image data from the controlling and processing unit; and a display operatively connected to the optical engine for forming an image based on the image data, the display comprises: an upper display comprising a spatial light amplitude modulator; a backlight unit, comprising light sources generating primary colors of a display color gamut; and an optical filter located between the upper display and the backlight unit and having a high reflectivity of visible light except for narrow-band transmission windows substantially coinciding with the primary colors.

### BRIEF DESCRIPTION OF THE DRAWINGS

For a better understanding of the nature and objects of the present invention, reference is made to the following detailed description taken in conjunction with the following drawings, in which:

FIG. 1 is a graph of reflectance as a function of wavelength of an optical filter at normal incidence;

FIG. 2 is a graph of transmittance as a function of wavelength of an optical filter at normal incidence;

FIG. 3 is a graph of transmittance as a function of wavelength of an optical filter at normal incidence compared to emission spectra of commercial LEDs;

FIG. 4 is a structure of a display device with a spectrally selective mirror/filter, according to an exemplary embodiment of the invention;

FIG. 5 is a flow chart demonstrating implementation of exemplary embodiments of the invention using spectrally selective mirror/filter; and

FIG. 6 is a block diagram of a wireless device for practicing exemplary embodiments of the invention.

### DETAILED DESCRIPTION

By way of introduction, always-on applications require a display with low power and high visibility indoors, outdoors, and in the dark. At the same time, high color quality, high resolution, and high motion quality are required for other applications. Traditional transflective (TF) LCDs have solved this dilemma to some extent but there is an inevitable trade-off between reflectance on one hand and power consumption/color saturation on the other hand. This trade-off worsens with higher pixel density so that high-resolution mobile displays are all transmissive (TM) and hence not low power.

Traditional TF LCDs divide each pixel into reflective and transmissive parts which utilize ambient light and backlight light, respectively. The reflective part could be common for the entire pixel (in a monochrome reflective mode) or common for each subpixel with a color filter on top (in a color reflective mode). To improve outdoor readability, one proposal is to use a normally-black TF LCD with a relatively large reflective area. To compensate for the inevitably lower TM aperture ratio, pale color filters and a high driving voltage are applied to improve transmittance. However, this leads to high driver power consumption and poor TM color performance. Also, this split-pixel approach does not work for high pixel densities, and the yield is low because color filters are easily damaged by the small cell gap in the reflective part of the pixel.

Improving outdoor readability of TM LCDs and OLEDs is done by increasing the luminance but this leads to increased power consumption and/or decreased color saturation. Low-reflectance design can relax the luminance requirements but there will always be some luminance needed. The OLEDs have an advanced low-power mode (ALPM) where only a fraction of pixels, colors/grey levels are used. This restricts the type of content in stand-by screens. For reading applications with power-saving infrequent updates, it requires the content to have a negative polarity (bright text on dark background) which is not ergonomically sound, i.e., long reading tasks may be better carried out on displays with positive polarity.

Reflective displays based on cholesteric or polymer-dispersed liquid crystals, electro-wetting, interferometric modulator (iMoD), electro phoresis, and electro chromism have good outdoor readability and low power but cannot satisfactorily display video and/or have poor contrast and/or pale colors. Also, they require auxiliary front light for operation in the dark.

TF field-sequential color (FSC) LCDs with a half mirror design (about 50% reflection and 50% transmission) have a color gamut limited by the backlight (often 140% NTSC or more), and can be made at high pixel densities, high aperture ratio, and with high yield. Because of the half mirror, however, there is still a trade-off between reflectance and transmittance.

It is noted that for the purpose of this invention the term “light” identifies a visible part of the optical spectrum.

A new apparatus and method (e.g., a computer readable memory) are presented for using a spectrally selective mirror/filter to facilitate high efficiency of backlighting and high reflectivity of ambient light in an electronic display.

According to an embodiment of the invention, the spectrally selective mirror/filter (or optical filter) may be placed between an upper display (spatial light amplitude modulator) and a backlight unit comprising light sources generating primary colors such as RBG of a display color gamut. This optical filter has a high reflectivity of visible light except for narrow-band transmission windows substantially coinciding with the primary colors.

In other words, narrow spectral bandwidths of backlights such as FSC backlights (currently using LEDs but in the future possibly lasers) can coincide/overlap with narrow-band transmission windows of the optical filter. Then the backlight unit comprising light sources such as LEDs generates primary colors of a display color gamut, so that the light emitted by the backlight sources passes through the optical filter to the upper display substantially without being reflected and/or attenuated, e.g., in the transmissive or transflecting mode of display operation.

On the other hand, light of all other wavelengths which are not in the narrow-band transmission windows is substantially reflected from the spectrally selected mirror/filter. This means that a large spectral portion of ambient light may be substantially reflected from the spectrally selective mirror/filter (optical filter) to facilitate a comfortable level of illumination of the observed image on the display, e.g., in reflective or transflecting mode of operation. This high reflectivity of the ambient light together with high optical efficiency of the backlight may be provided at the same time using the spectrally selective mirror/filter as described herein without trade-off between reflectance and backlight related display parameters.

The spectrally selective mirror/filter may be implemented in a variety of ways. For example it may be implemented as a structure with a continuously varying period corresponding to the interference condition (Fabry-Perot etalon/filter or Bragg) of constructive interference for the reflected light for almost all wavelengths of visible light. However,-this structure lacks the periods corresponding to the Bragg condition of the light from the backlight, which therefore instead is transmitted through the mirror/filter. By collimating the light from the backlight, the Bragg condition is fulfilled only for the wavelengths of the backlight, and the transmission peaks of the mirror/filter can therefore be spectrally very narrow. Light collimation is already used in broadband backlight solutions, for example using light turning films, micro prisms, and micro lenses. Backlight collimation as good as 9 degrees FWHM has been demonstrated by Kälil Käläntär, “A Directional Backlight with Narrow Angular Luminance Distribution for Widening the Viewing Angle of a LCD with a Front-Surface Light-Scattering Film”, Paper 60.4, Symposium of the Society for Information Display, 2011.

The periodic structure can be implemented by depositing multi-layer dielectric films on either glass or plastic (see FIG. 1).

FIG. 1 is a graph of reflectance as a function of wavelength of an optical (notch) filter at normal incidence. Three reflectance minimums 10, 12 and 14 in FIG. 1 may correspond to three primary colors such as RBG used by the backlight unit of the display.

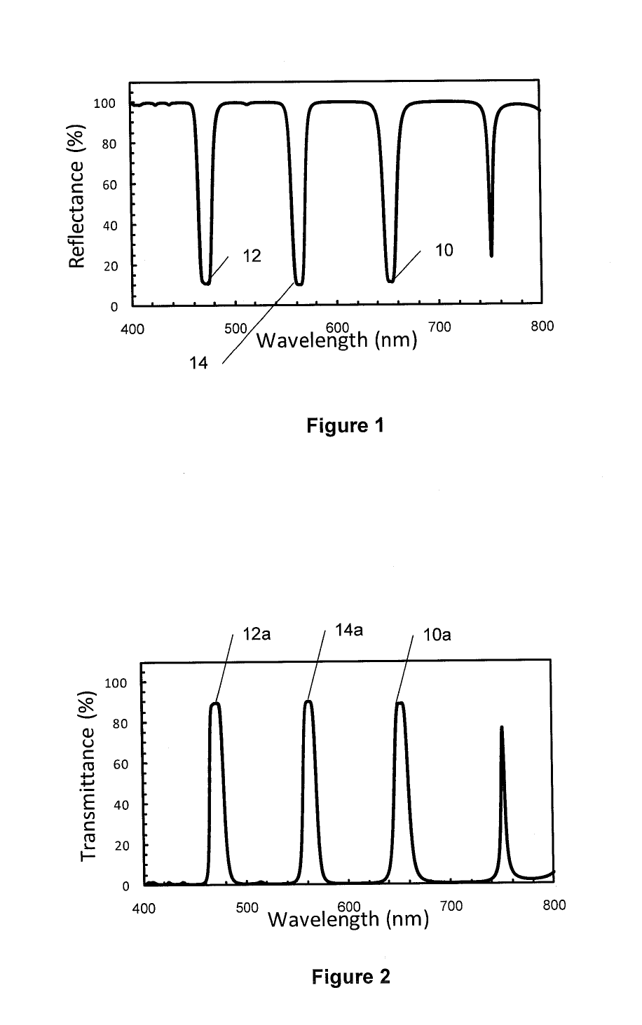

FIG. 2 shows a graph of transmittance as a function of wavelength of an optical filter at normal incidence. Three transmittance maximums 10a, 12a and 14a in FIG. 2 may correspond to three primary colors such as RBG used by the backlight unit of the display.

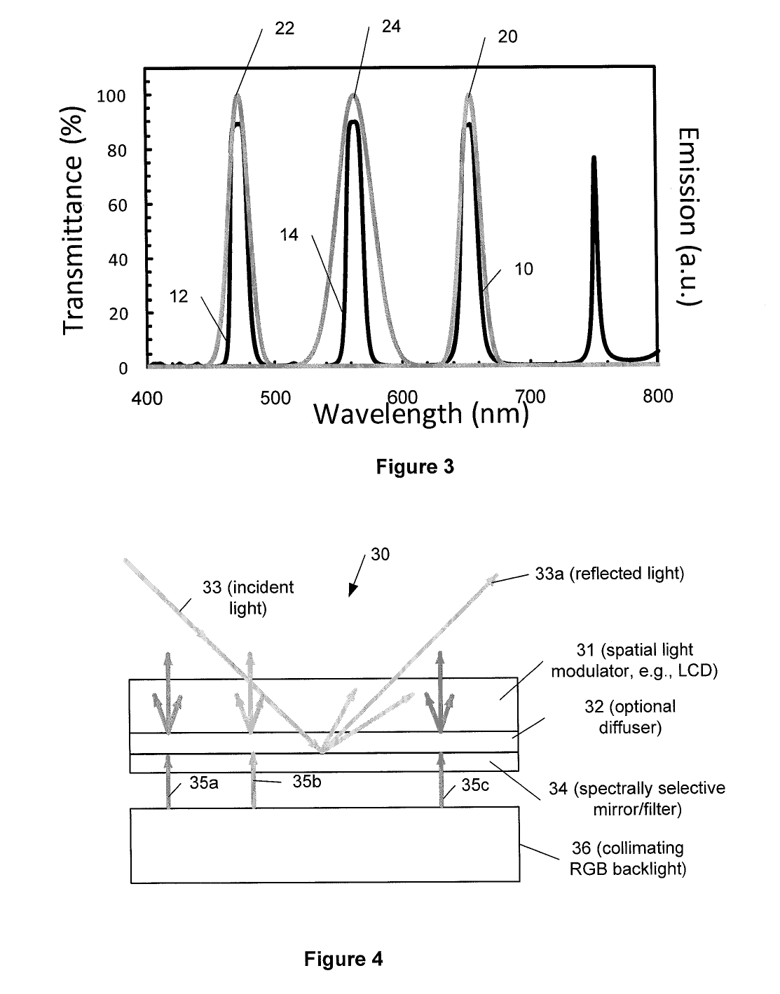

FIG. 3 shows a graph of transmittance as a function of wavelength of an optical filter at normal incidence shown in FIG. 1 compared to emission spectra of commercial LEDs. It is seen that the LED spectrum 20, 22 and 24 have rather close correlation with reflectance minimums 10, 12 and 14. For displays with more than three primary colors, the number of transmit peaks is increased accordingly.

Furthermore, there exist broad-band reflectors such as enhanced specular reflectors, ESR, for polarization recycling. The ESR consists of several hundred layers with Bragg/Fabry-Perot conditions for all visible wavelengths and incident angles. It is possible to make ESR structures for parts of the visible spectrum and then laminate those films together to achieve an optical notch filter similar to that as shown in FIG. 1.

Another way to implement the spectrally selective mirror/filter, as described herein, may be to use reactive mesogens (RMs). RMs are liquid crystalline (LC) materials that can be permanently fixed in the LC phase by polymerization. A cholesteric LC (CLC) with a helical structure reflects light corresponding to the Bragg/Fabry-Perot condition defined by the period of the helix and the reflected and transmitted light are circularly polarized with opposite handednesses. The Bragg/Fabry-Perot condition is fulfilled for n×p where n is the resultant refractive index and p the chiral pitch of the CLC. n varies between the ordinary (nₒ) and extraordinary (nₑ) refractive index of the CLC so, by varying n and nₑ−nₒ=Δn (birefringence), broadband reflective films in the desired wavelength range can be fabricated. The Bragg/Fabry-Perot condition can also be changed by the pitch p which can be changed by curing the RM CLC at elevated temperatures, see Kwang-Soo Bae, Yeong-Joon Jang, Yeon-Kyu Moon, Sung-Gon Kang, Uiyeong Cha, Chang-Jae Yu, Jae Eun Jang, Jae Eun Jung, and Jae-Hoon Kim, “Multicolor Cholesteric Liquid Crystal Display in a Single-Layered Configuration using a Multi-Pitch Stabilizations”, Jpn. J. Appl. Phys. 49 (2010) 084103). CLCs with sharp reflection bands in red, green, and blue, respectively, have been demonstrated by M. Suzuki, N. Fujiwara, “Energy Efficient LCDs (e2-LCDs) Using Photonic Crystal Structure Based on Cholesteric LC Materials”, Paper LCT3-1, International Display Workshops, 2010. An optical notch filter would consist of three CLC films. An additional advantage of CLC over wavelength-selective ESR or multi-layer dielectrics is that polarization recycling is made easy with a metal reflector. Whereas conventional DBEF and ESR solutions requires multiple reflections, a CLC with a metal reflector requires only one reflection to change the polarization.

Yet another possibility for implementing the spectrally selective mirror/filter is to use a high reflectivity, high-finess Fabry-Perot etalon filter (see, for example, U.S. Pat. No. 4,813,756). The free spectral range FSR of such a filter is given by

FSR=λ²/2Ln (1),

where λ is a wavelength, L is etalon thickness and n is etalon's index of refraction.

Estimation of Equation 1 for FSR=90 nm (an approximate distance between primary colors, e.g., between red and green, or between green and blue primary colors), λ=560 nm and n=1.5, gives the value for L=1.16 micron. Then the etalon may be design to have a thickness of about 1.16 micron with index of refraction of about 1.5 and high reflective coating on both sides of the etalon with at least 95% reflectivity in the visible part of spectrum.

The photopic reflectance of the mirror/filter with the spectrum shown in FIG. 1 and under ambient light condition D65 (daylight) is 84% at normal incidence while the transmittance (see FIG. 2) of the backlight is ≧90% for narrow-band sources such as lasers or quantum-dot LEDs. Compared to a 50% reflectance/transmittance broad-band half mirror, transmittance and reflectance is simultaneously enhanced by 80% and 68%, respectively.

In a further embodiment, the methods disclosed herein may be further used for matching white point of the reflected ambient light for more accurate color representation (e.g., see U.S. Pat. No. 7,486,304 for dynamic color gamut). For example, if the spectrum of the ambient light is identified or its tristimulus or RGB components are measured, then the compensation (e.g., pixel emission/transmission of the upper display) may follow each measured white point, thus providing a matching white point at the same time. Instead of matching white point, the lower display may generate a background image of a chroma and hue value (e.g., in the CIE L*a*b* color space) having the opposite sign and 180 degrees difference, respectively, of that of the reflected ambient light. In this way not only luminance contrast is maximized but also color contrast. For example, a reflective display in a yellowish illumination can enhance the color contrast by applying a blueish hue in the transmissive mode.

FIG. 4 shows a structure of a display device 30 with a spectrally selective mirror/filter (optical filter) 34, according to an exemplary embodiment of the invention. The spectrally selective mirror 34 is below an upper display 31 (e.g., an LCD, or in general, spatial light modulator). The optical filter 34 can be deposited on the lower surface of the display 31 or optionally can be separated from the display 31 by a diffusive layer 32 (which may be used, e.g., for minimizing parallax and/or specular reflection/glare, and provide at least a partly Lambertian reflection). The optical filter 34 is located between the display 31 and the backlight unit 36 such as collimating RBG backlight unit. Different options for constructing the optical filter 34 are discussed in detail herein.

The display (spatial light amplitude modulator) could utilize any transmissive technology, e.g., retardation-based LCD with polarizer(s), electro-chromic displays, polymer-dispersed LCDs, MEMS, anisotropic dye-doped LCDs. Furthermore, the display could be active or passive (dot) matrix, multiplexed segment, and direct-drive iconic displays, and even optically, magnetically, or thermally addressed/activated. The backlight unit may be also implemented as any kind of emissive display such as OLED display.

Then the back light comprising, for example, three primary color component 35a, 35b and 35c (such as RBG) of the color gamut can propagate through the optical filter 34 without being substantially attenuated because the transmission spectral windows of the optical filter 34 match to the bandwidths of the of the color components 35a, 35b and 35c. At the same time the ambient light 33 having broad visible spectrum will be substantially reflected (shown as a beam 33a) from the optical filter 34 as explained herein.

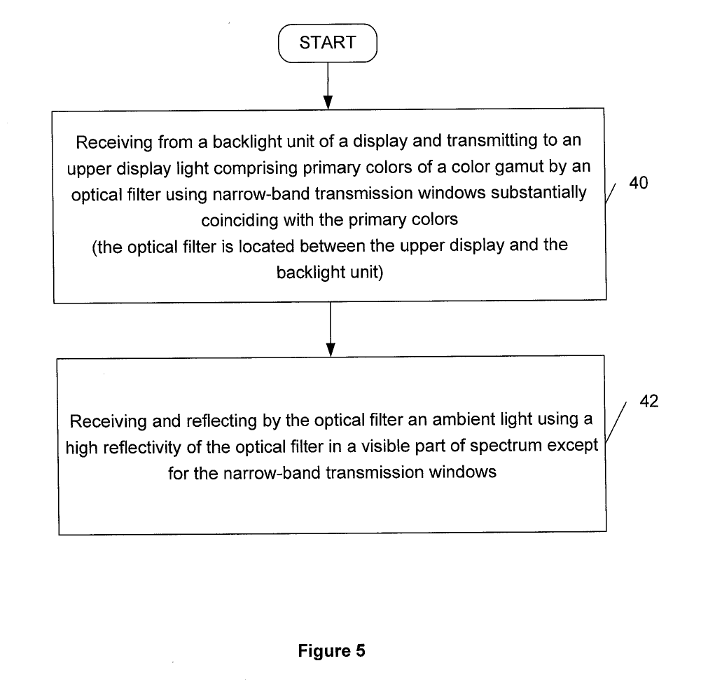

FIG. 5 shows an example of a flow chart demonstrating implementation of exemplary embodiments of the invention using a spectrally selective mirror/filter (optical filter). It is noted that the order of steps shown in FIG. 5 is not absolutely required, so in principle, the various steps may be performed out of the illustrated order. Also certain steps may be skipped or selected steps or groups of steps may be performed in a separate application.

In a method according to this exemplary embodiment, as shown in FIG. 5, in a first step 40, the optical filter receives from a backlight unit of a display and transmits to an upper display light comprising primary colors of a color gamut using narrow-band transmission windows substantially coinciding with the primary colors (e.g., RBG) of the color gamut, where the optical filter is located between the upper display and the backlight unit. In a next step 42, the optical filter receives and reflects an ambient light using a high reflectivity of the optical filter in a visible part of spectrum except for the narrow-band transmission window, as described herein.

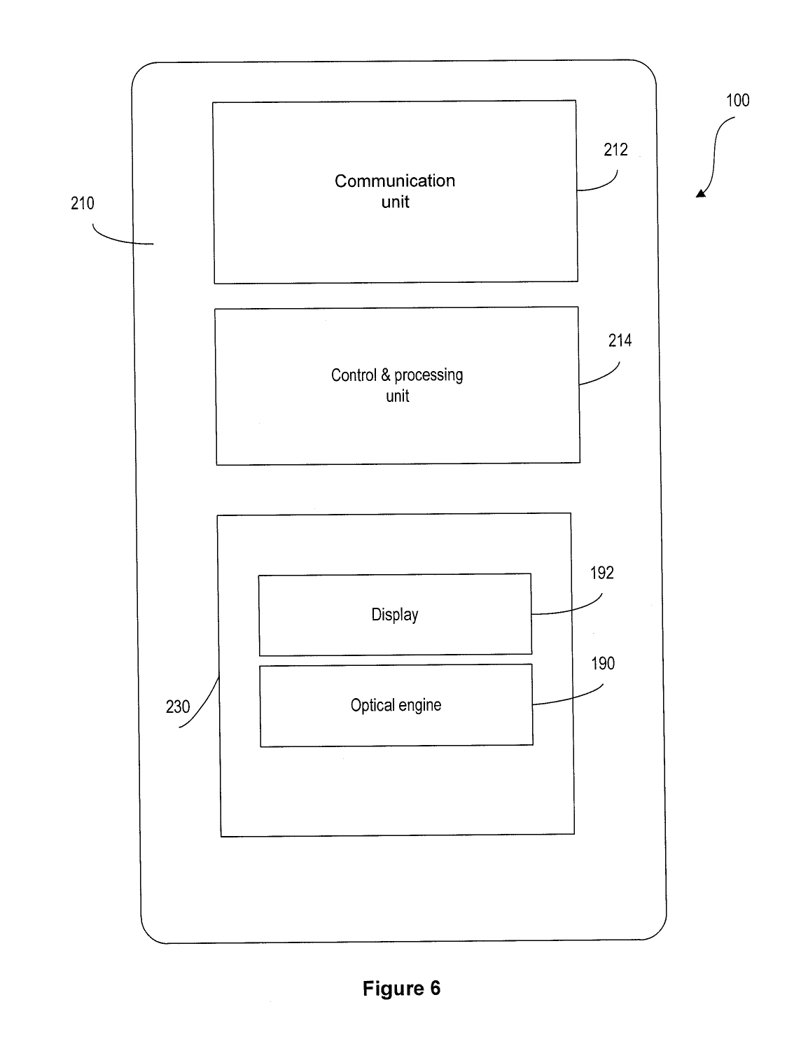

FIG. 6 shows an example of a simplified block diagram of a device (such as wireless device) 100 which comprises a display 192 containing the spectrally selective mirror/filter described herein. FIG. 6 is a simplified block diagram of various electronic devices that are suitable for practicing the exemplary embodiments of this invention, e.g., in reference to FIGS. 1-5. The electronic device 100 may be implemented as a portable or non-portable electronic device, a wireless communication device with a display, a camera phone, personal digital assistant (PDA), and the like.

As shown in FIG. 6, the portable device 100 has a housing 210 to house a communication unit 212 for receiving and transmitting information from and to an external device (not shown). The portable device 100 also has a controlling and processing unit 214 for handling the received and transmitted information, and a virtual display system 230 for viewing. A display system 230 includes the display or an image source 192 and an optical engine 190. The controlling and processing unit 214 is operatively connected to the optical engine 190 to provide image data to the display 192 to display an image thereon.

Furthermore, the display 192, as depicted in FIG. 6, can be a sequential color LCD color filter LCD, LCOS (Liquid Crystal On Silicon) device, an OLED (Organic Light Emitting Diode) array, an MEMS (micro-electro-mechanical system) device or any other suitable display device operating in transmission, reflection, emission or transflective mode.

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

What is claimed is:

1. An apparatus, comprising:
an upper display comprising a spatial light amplitude modulator;
a backlight unit, comprising light sources generating primary colors of a display color gamut; and
an optical filter located between the upper display and the backlight unit and having a high reflectivity of visible light except for narrow-band transmission windows substantially coinciding with the primary colors.

2. The apparatus of claim 1, wherein the optical filter is implemented using a multi-layer dielectric film.

3. The apparatus of claim 1, wherein the optical filter is implemented using enhanced optical reflector.

4. The apparatus of claim 1, wherein the optical filter is implemented using reactive mesogens.

5. The apparatus of claim 1, wherein the optical filter is implemented using a single-layer Fabry-Perot etalon having high reflectivity surfaces and high finesse.

6. The apparatus of claim 1, wherein backlight unit is an organic light-emitting diode display.

7. The apparatus of claim 1, wherein light sources generating primary colors are narrow band light emitting diodes.

8. The apparatus of claim 1, wherein light sources generating primary colors are lasers.

9. The apparatus of claim 1, wherein the apparatus is comprised of a display comprising the upper display, the backlight unit and the optical filter.

10. A method comprising:
receiving from a backlight unit of a display and transmitting to an upper display light comprising primary colors of a color gamut by an optical filter using narrow-band transmission windows substantially coinciding with the primary colors; and
receiving and reflecting by the optical filter an ambient light using a high reflectivity of the optical filter in a visible part of spectrum except for the narrow-band transmission window, where the optical filter is located between the upper display and the backlight unit.

11. The method of claim 10, wherein the optical filter is implemented using a multi-layer dielectric film.

12. The method of claim 10, wherein the optical filter is implemented using an enhanced optical reflector.

13. The method of claim 10, wherein the optical filter is implemented using reactive mesogens.

14. The method of claim 10, wherein the optical filter is implemented using a single-layer Fabry-Perot etalon having high reflectivity surfaces and high finesse.

15. The method of claim 10, wherein backlight unit is an organic light-emitting diode display.

16. The method of claim 10, wherein light sources generating primary colors are narrow band light emitting diodes.

17. The method of claim 10, wherein light sources generating primary colors are lasers.

18. An electronic device, comprising:
a controlling and processing unit;
an optical engine operatively connected to the controlling and processing unit for receiving image data from the controlling and processing unit; and
a display operatively connected to the optical engine for forming an image based on the image data, the display comprises:
an upper display comprising a spatial light amplitude modulator;
a backlight unit, comprising light sources generating primary colors of a display color gamut; and
an optical filter located between the upper display and the backlight unit and having a high reflectivity of visible light except for narrow-band transmission windows substantially coinciding with the primary colors.

19. The electronic device of claim 18, wherein the optical filter is implemented using a multi-layer dielectric film, an enhanced optical reflector, reactive mesogens or a single-layer Fabry-Perot etalon having high reflectivity surfaces and high finesse.

20. The electronic device of claim 18, wherein light sources generating primary colors are narrow band light emitting diodes or lasers.
